(19) United States
(12) Patent Application Publication
(10) Pub. No.: US 2010/0270367 A1
(43) Pub. Date: Oct. 28, 2010

(54) CARTON WITH DISPLAY PANEL

(76) Inventor: Allen M. Brandenburger, Decatur, GA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/768,144

(22) Filed: Apr. 27, 2010

Related U.S. Application Data
(60) Provisional application No. 61/214,763, filed on Apr. 28, 2009.

(51) Int. Cl. B65D 5/46; B65D 25/54; B31B 3/00

(52) U.S. Cl. 229/117.13; 229/162.1; 493/162

(57) ABSTRACT

A carton for containing at least one article. The carton comprises a plurality of side panels extending at least partially around an interior of the carton. At least one of the plurality of side panels comprises a display feature. A plurality of bottom end flaps are respectively foldably connected to respective side panels of the plurality of side panels. The bottom end flaps at least partially form a closed bottom of the carton. A display panel is positioned in face-to-face relationship with the at least one of the plurality of side panels. The display panel is adjacent the display feature.

### CROSS-REFERENCE TO RELATED APPLICATION

This application claims the benefit of U.S. Provisional Patent Application No. 61/214,763, filed Apr. 28, 2009.

### INCORPORATION BY REFERENCE

U.S. Provisional Patent Application No. 61/214,763, which was filed on Apr. 28, 2009, is hereby incorporated by reference for all purposes as if presented herein in its entirety.

U.S. Pat. No. 7,617,969, issued Nov. 17, 2009, is hereby incorporated by reference for all purposes as if presented herein in its entirety.

### BACKGROUND OF THE DISCLOSURE

The present disclosure generally relates to cartons for holding products, and more particularly, to a carton with a display panel.

### SUMMARY OF THE DISCLOSURE

In general, one aspect of the disclosure is directed to a carton for containing at least one article. The carton comprises a plurality of side panels extending at least partially around an interior of the carton. At least one of the plurality of side panels comprises a display feature. A plurality of bottom end flaps are respectively foldably connected to respective side panels of the plurality of side panels. The bottom end flaps at least partially form a closed bottom of the carton. A display panel is positioned in face-to-face relationship with the at least one of the plurality of side panels. The display panel is adjacent the display feature.

In another aspect, the disclosure is generally directed to a blank for forming a carton for holding at least one article. The blank comprises a plurality of side panels for extending at least partially around an interior of the carton formed from the blank. At least one of the plurality of side panels comprises a display feature. A plurality of bottom end flaps are respectively foldably connected to respective side panels of the plurality of side panels. The bottom end flaps are for at least partially forming a closed bottom of the carton. A display panel is for being positioned in face-to-face relationship with the at least one of the plurality of side panels and is for being adjacent the display feature in the carton formed from the blank.

In another aspect, the disclosure is generally directed to a method of assembling a carton. The method comprises obtaining a blank comprising a plurality of side panels. At least one of the plurality of side panels comprises a display feature. The blank comprises a plurality of bottom end flaps respectively foldably connected to respective side panels of the plurality of side panels, and a display panel. The method comprises positioning the side panels to at least partially enclose an interior of the carton, positioning the display panel to be in face-to-face relationship with the at least one of the plurality of side panels wherein the display panel is adjacent the display feature, and forming a closed bottom by positioning the bottom end flaps to at least partially form the closed bottom of the carton.

In another aspect, the disclosure is generally directed to a carton for containing at least one product. The carton comprises a bottom, a plurality of side panels extending upwardly from the bottom. A display panel is foldably connected to one of the plurality of side panels and is positioned in face-to-face relationship with at least one of the side panels.

In one aspect of the disclosure, the carton comprises an access flap in the side panel that is in face-to-face relationship with the display panel. When the access flap is opened to create a display opening, the display panel is displayed.

In one aspect of the disclosure, the carton comprises a plurality of top panels respectively foldably connected to one of the plurality of side panels. The access flap can comprises a portion of one of the side panels and one of the top panels. The display panel can be in face-to-face relationship with the one of the side panels and the one of the top panels.

In one aspect of the disclosure, the display panel includes a side panel portion foldably connected to one of the side panels and a top flap foldably connected to the side panel portion.

In one aspect of the disclosure, the carton includes a reinforcement panel foldably connected to one of the side panels and the display panel. The reinforcement panel is in face-to-face relationship with one of the side panels and the display panel is in face-to-face relationship with another of the side panels.

Other aspects, features, and details of the present disclosure can be more completely understood by reference to the following detailed description of exemplary embodiments taken in conjunction with the drawings and from the appended claims.

The various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an exterior surface of a blank for forming a carton of a first embodiment of the disclosure.

FIG. 2 is a front perspective of the blank of FIG. 1 partially formed into the carton of the first embodiment.

FIG. 3 is a view of the interior of the partially formed carton of FIG. 2.

FIG. 4 is a front perspective of the carton of the first embodiment.

FIG. 5 is a front perspective of the carton with a display feature removed to show a display feature.

FIG. 6 is a plan view of an exterior surface of a blank for forming a carton of a second embodiment of the disclosure.

Corresponding parts are designated by corresponding reference numbers throughout the drawings.

### DETAILED DESCRIPTION OF THE EXEMPLARY EMBODIMENTS

The present disclosure generally relates to a carton that is used to hold articles or products, such as meals served in the Quick Serve Restaurant (QSR) industry, but the carton can be used to hold other articles or products, including other food products and/or other nonfood products (e.g., toys, premiums and promotional items, coupons, etc.). The present disclosure generally relates to various display features and reinforcement features. The carton of the present disclosure can have various handle features, opening features, closing features, and/or other features that are the same or different than the various features listed and described herein. For example, U.S. Pat. No. 7,617,969, issued Nov. 17, 2009, and incorporated by reference herein for all purposes (referred to as the “'969 patent” below), discloses cartons and blanks having various features. In this specification, the terms “lower,” “bottom,” “upper” and “top” indicate orientations determined in relation to fully erected and upright cartons.

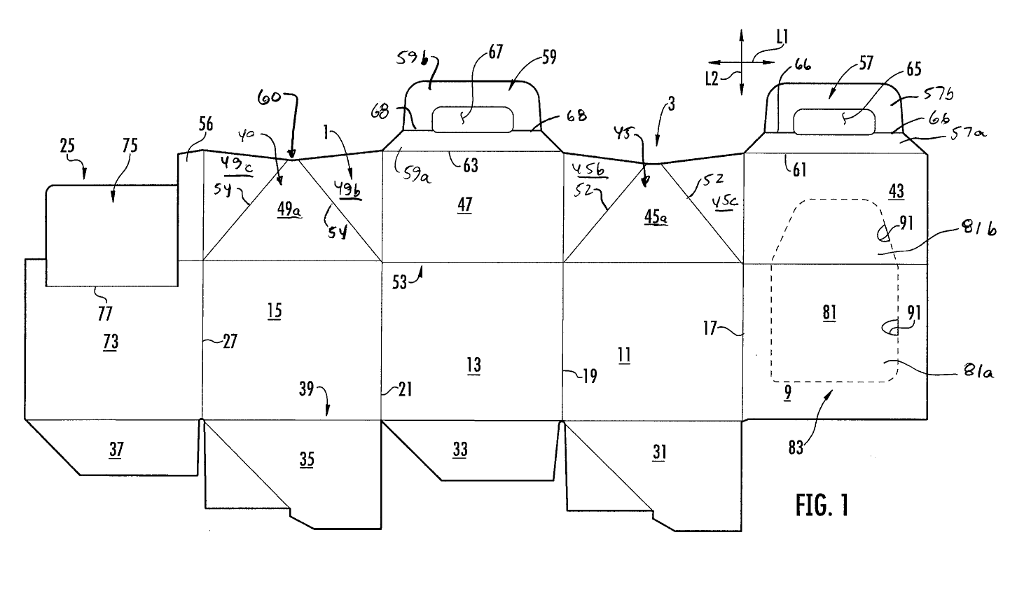

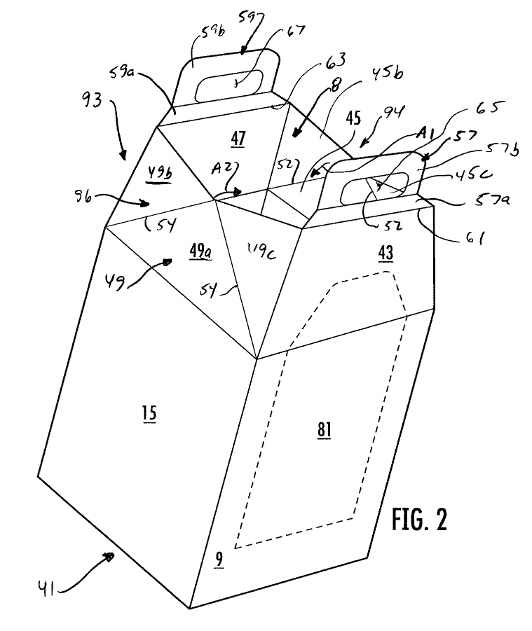

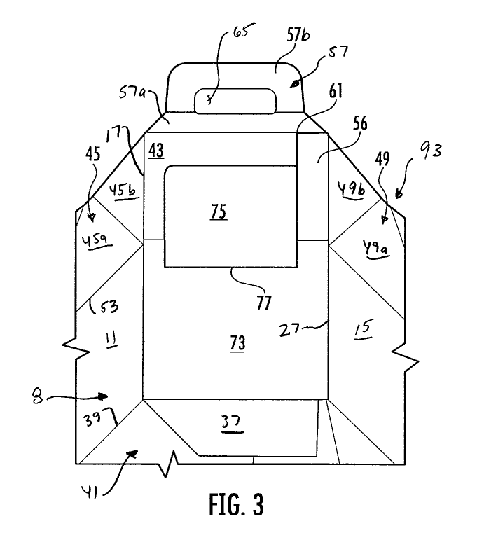

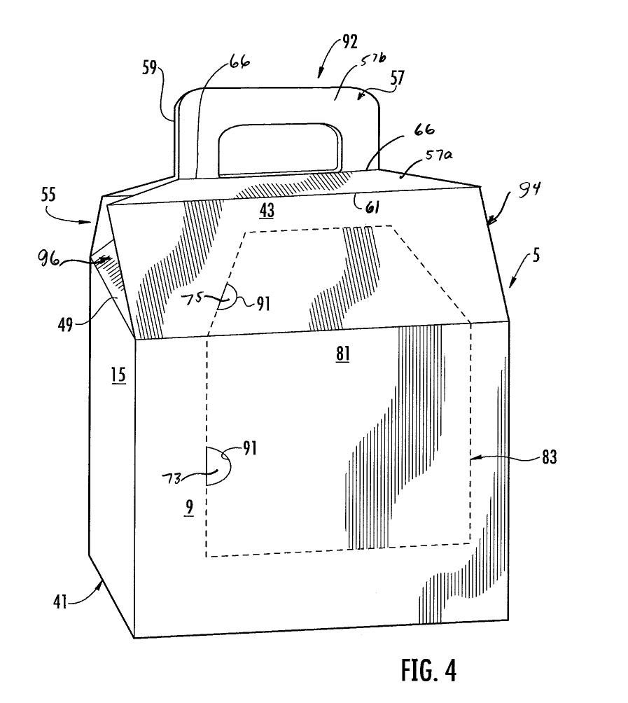

FIG. 1 is a plan view of the exterior surface 1 of a blank, generally indicated at 3, used to form a carton 5 (FIG. 4) according to a first exemplary embodiment of the disclosure. The carton 5 can be used to hold premiums and promotional items (e.g. kids meal toys), other products usually associated with QSR meals, or other nonfood products or food products. Typically graphics will be displayed on the exterior surface 1 of the blank that is formed into the exterior surface of the carton 5, but the graphics could also be displayed on an interior surface 8 (FIGS. 2 and 3) without departing from the disclosure. In the various embodiments of the disclosure, the carton 5 has various opening features, display features, reinforcement features, and other features that enhance the marketing of a particular promotional venture.

The blank 3 includes a longitudinal axis L1 that extends generally in the direction of the length of the blank, and a lateral axis L2 that extends generally in the direction of the width of the blank. The blank 3 includes panels and fold lines that are generally positioned relative to the longitudinal axis L1 and the lateral axis L2. The panels and fold lines may be alternative arranged and positioned to be oblique relative to the longitudinal direction L1 and/or the lateral direction L2 without departing from the scope of the disclosure.

As shown in FIG. 1, the blank 3 has a plurality of side panels that include a front (first) side panel 9, a right (second) side panel 11, a rear (third) side panel 13, and a left (fourth) side panel 15. The side panels 9, 11, 13, 15 are respectively foldably connected at respective fold lines 17, 19, 21 that extend generally laterally across a width of the blank 3. The blank 3 includes a display panel 25 that is foldably connected to the left side panel 15 at a fold line 27 that extends generally laterally across a width of the blank.

In the embodiment of FIG. 1, the right side panel 11, rear side panel 13, left side panel 15, and display panel 25 include respective bottom end flaps 31, 33, 35, 37. The bottom end flaps 31, 33, 35, 37 are foldably connected to a respective side panel 11, 13, 15 or display panel 25 at a fold line 39 that extends generally in the longitudinal direction L1 of the blank 3. The bottom end flaps 31, 33, 35, 37 are at least partially overlapped to close a bottom 41 of the carton 5 in a similar manner as disclosed in the '969 patent.

As shown in FIG. 1, the front side panel 9, right side panel 11, rear side panel 13, and left side panel 15 include respective top panels 43, 45, 47, 49. The top panels 43, 45, 47, 49 are foldably connected to a respective side panel 9, 11, 13, 15 at a fold line 53 that extends generally in the longitudinal direction L1 of the blank 3. The top panels 43, 45, 47, and 49 are positioned to close a top 55 of the carton 5. The top panels 43, 45, 47, 49 can have panels, fold lines, or other features for closing the top 55 such as the features disclosed in the '969 patent or the top panels can have other closing or locking features. In the illustrated embodiment, the top panels 45, 49 have respective oblique fold lines 52, 54 that extend from the fold line 53 to a top edge 60 of the blank 3. The oblique fold lines 52 divide the top panel 45 into a central portion 45a and two end portions 45b, 45c. The oblique fold lines 54 divide the top panel 49 into a central portion 49a and two end portions 49b, 49c. The blank 3 includes an adhesive flap 56 foldably connected to the top panel 49 at the fold line 27.

As shown in FIG. 1, the front top panel 43 and the rear top panel 47 have respective handle panels 57, 59 foldably connected to a top panel at fold lines 61, 63. In the illustrated embodiment, the handle panels 57, 59 include a lower portion 57a, 59a, and an upper portion 57b, 59b. The upper portions 57b, 59b are generally U-shaped, and the handle panels 57, 59 have a respective handle opening 65, 67 for grasping and carrying the carton 5. In one embodiment, the upper portions 57b, 59b of the handle panels 57, 59 are foldably connected to the lower portions 57a, 57b at respective longitudinal fold lines 66, 68 extending from a respective handle opening 65, 67. The handle panels 57, 59, could be otherwise shaped, arranged, and/or positioned without departing from the disclosure. For example, the handle panels 57, 59 could include other features (e.g., closing or locking features) without departing from the disclosure.

In the first embodiment, the display panel 25 includes a side panel portion 73 and a top flap 75. The top flap 75 is foldably connected to the side panel portion 73 at a fold line 77 that extends generally in the longitudinal direction L1 of the blank 3. More than one fold line 77 can be provided to facilitate folding of the top flap 75 without departing from the scope of the disclosure. The display panel 25 could be otherwise shaped, arranged, and/or configured without departing from the scope of this disclosure.

In the first embodiment, the blank 3 includes an access flap 81 (broadly “access feature) that is at least partially defined by a tear line 83 in the front side panel 9 and the front top panel 43. The tear line 83 can have portions that extend generally in the longitudinal direction L1 and the lateral direction L2 such that the access flap 81 is generally polygonal-shaped, or the tear line can be irregular so that the access flap has an irregular shape. The tear line 83 can include other forms of line of weakening (e.g., a cut line, fold line, etc.) without departing from the scope of the disclosure. In alternative embodiments, the access flap 81 could be foldably connected to the front side panel and/or the front top panel 43 by a fold line, or the access flap could be foldably connected to other portions of the blank 3.

The access flap 81 comprises a first portion 81a in the front side panel 9 and a second portion 81b in the front top panel 43. The second portion 81b of the access flap 81 is foldably connected to the first portion 81a by the portion of the fold line 53 that connects the front top panel 43 to the front panel 9 and extends between the tear line 83.

In one embodiment, the access flap 81 includes two finger notches 91 that form respective openings in the front side panel 9 and the front top panel 43. The finger notches 91 could be omitted without departing from the disclosure. Further, the access flap 81 could be otherwise shaped, arranged, configured, or omitted from the blank 3 and carton 5 without departing from the scope of the disclosure. In another embodiment, the access feature 81 could comprise an opening in the blank 3, wherein the opening is at least in the front side panel 9 or the front top panel 43. Also, the access feature comprising the opening could be formed by a cut line of approximately the same shape as the tear line 83. The access feature could be otherwise shaped, arranged, and/or configured without departing from the disclosure.

An acceptable method for forming the carton 5 from the blank 3 will be described in the following, in accordance with one exemplary embodiment of the disclosure. In accordance with one exemplary embodiment, the blank 3 can be erected into the carton 5 by folding along fold lines 19, 27 and positioning the adhesive flap 56 and the display panel 25 to be in generally face-to-face contact with the front top panel 43 and the front side panel 9, respectively. The adhesive flap 56 can be secured to the front top panel 43 by adhesive such as glue. Prior to attaching the adhesive flap 56 to the front top panel 43, the bottom flaps 31, 33, 35, 37 can be positioned to facilitate forming a closed bottom panel 41 of the carton 5. The side panels 9, 11, 13, 15 of the partially assembled blank 3 can be folded about fold lines 17, 19, 21, 27 to form a generally open tray 93 (FIGS. 2 and 3) having an open top configuration and having a bottom 41 that is closed by the positioning of the bottom end flaps 31, 33, 35, 37. As shown in FIG. 3, the exterior surface of the display panel 73 overlaps and is in face-to-face contact with an interior surface of the front side panel 43. The

[symbol]

The top of the tray 93 can be positioned in a closed configuration by folding the front top panel 43 and rear top panel 47 inward so that the handle panels 57, 59 are placed in generally face-to-face relationship. As shown in FIG. 2 the opposite top panels 45, 49 are operative for defining opposite gable areas 94, 96 in the closed configuration of the carton. When the front and rear top panels 43, 47 are folded inward, the left and right top panels 45, 49 are folded inward in the direction of arrows A1, A2 (FIG. 2). In the closed configuration, the gable area 96 is formed by the end portion 49b of the top panel 49 being folded to be in face-to-face contact with the rear top panel 47 and the end portion 49c of the top panel 49 being folded to be in face-to-face contact with the front top panel 43. Similarly, the gable area 94 is formed by the end portion 45b of the top panel 45 being folded to be in face-to-face contact with the rear top panel and the end portion 45c being folded to be in face-to-face contact with the front top panel 43. Alternatively the end portions 45b, 49b can be in close proximity to the rear top panel 47 and the end portions 45c, 49c can be in close proximity to the front top panel 43. Alternatively, the left and right top panels 45, 49 may be first folded inward prior to initiating folding of the front and rear top panels 43, 47. When the front top panel 43 is folded inward, the top flap 75 is folded inward and remains in generally face-to-face contact with the front top panel. The top flap 75 can be adhesively secured to a portion of the front top panel 43 or the top flap can remain free from attachment to the front top panel. Also, the side panel portion 73 of the display panel 25 can be adhesively secured to a portion of the front side panel 9 or the side panel portion can remain free from attachment to the front side panel. When the front and rear top panels 43, 47 are positioned to close the carton 5, the handle panels 57, 59 are brought into face-to-face contact to form a handle 92 of the carton.

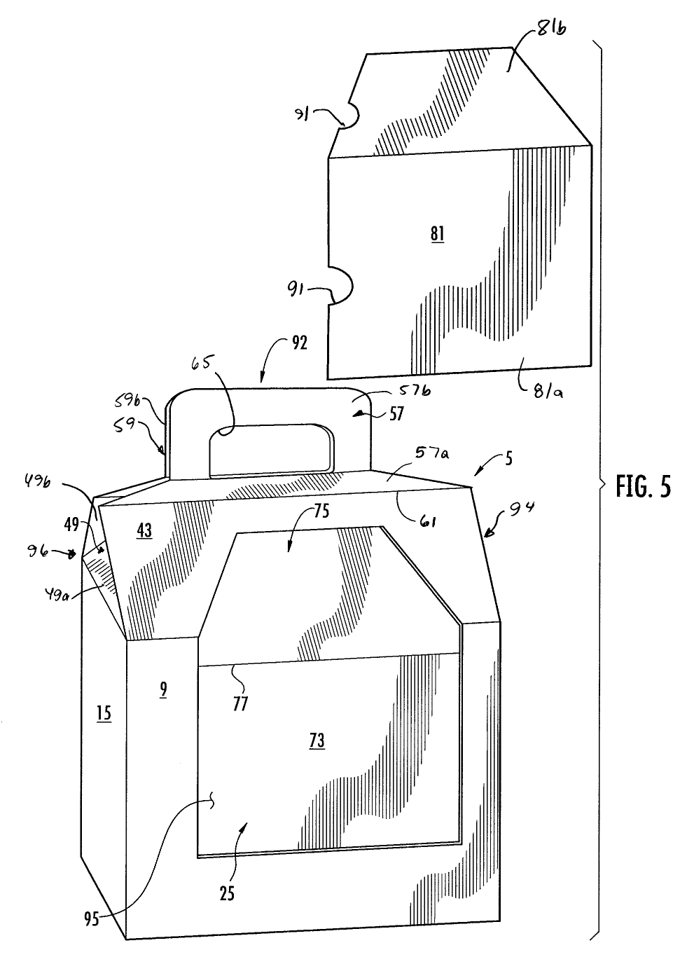

As shown in FIGS. 4 and 5, the access flap 81 can be grasped and separated from the carton 5 at the tear line 83 to create an access opening 95 in the front side panel 9 and the front top panel 43. When the access flap 81 is removed, the top flap 75 and the side panel portion 73 of the display panel 25 are displayed through the access opening 95. The exterior surface of the display panel 25 can include marketing indicia such as graphics that are displayed when the access flap 81 is opened. Alternatively, the access flap 81 can remain hingedly connected to the front side panel 9 and/or the front top panel 43 so that the display panel 25 is exposed by opening the access flap 81 without completely removing the access flap from the carton 5. The carton 5 can be formed by other alternative forming steps and the display panel 25 can be displayed by other alternative opening steps without departing from the disclosure.

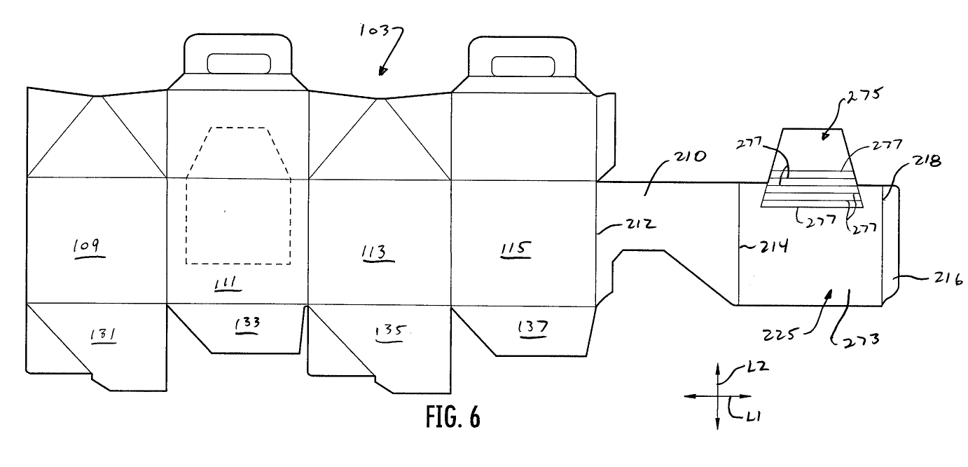

FIG. 6 illustrates a blank 103 of a second embodiment of the disclosure for forming a carton having similar features as the first embodiment. Accordingly, similar or identical features of the embodiments are provided with like or identical reference numbers. The blank 103 has a left (first) side panel 109, a front (second) side panel 111, a right (third) side panel 113, and a rear (fourth) side panel 115. In the illustrated embodiment, the blank 103 includes a reinforcement panel 210 foldably connected to the rear side panel 115 at a fold line 212. The display panel 225 is foldably connected to the reinforcement panel 210 at a fold line 214. The blank 103 includes an adhesive flap 216 foldably connected to the display panel 25 at a fold line 218. In the embodiment of FIG. 6, the blank 103 comprises bottom end flaps 131, 133. 135, 137 that are respectively foldably connected to the four side panel 109, 111, 113, 115, and are similar to the bottom end flaps of the first embodiment. In the embodiment of FIG. 6, the display panel 225 is free from connection to a bottom end flap. The display panel 225 comprises a top flap 275 that is foldably connected to a side panel portion 273 at a plurality of fold lines 277 that extend generally in the longitudinal direction L1 of the blank 303.

The blank 103 of FIG. 6 can be formed into a carton in a generally similar manner as described above for the first embodiment. The reinforcement panel 210 is folded about fold line 212 and is placed in generally face-to-face contact with the left side panel 109. The display panel 225 is folded about fold line 214 and is placed in generally face-to-face contact with the front side panel 111 and is positioned similar to the display panel 25 of the first embodiment. Alternatively, the blank 103 can be formed into a carton by other steps and the blank 103 of the second embodiment could have other features.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing at least one article, the carton comprising:
a plurality of side panels extending at least partially around an interior of the carton, at least one of the plurality of side panels comprises a display feature;
a plurality of bottom end flaps respectively foldably connected to respective side panels of the plurality of side panels, wherein the bottom end flaps at least partially form a closed bottom of the carton; and
a display panel positioned in face-to-face relationship with the at least one of the plurality of side panels, the display panel being adjacent the display feature.

2. The carton of claim 1 wherein an exterior surface of the display panel is in face-to-face contact with an interior surface of the at least one of the plurality of side panels.

3. The carton of claim 1 wherein the display panel comprises a side panel portion and a top flap foldably connected to the side panel portion.

4. The carton of claim 3 wherein the top flap comprises a plurality of lateral fold lines extending across the top flap to facilitate bending of the top flap.

5. The carton of claim 3 wherein the side panel portion is foldably connected to one of the plurality of side panels.

6. The carton of claim 1 wherein the display feature comprises an access flap removably connected to the at least one side panel for forming a display opening, the display panel being positioned relative to the access flap for being displayed in the display opening upon removal of the access flap.

7. The carton of claim 6 further comprising a plurality of top panels respectively foldably connected to respective side panels of the plurality of side panels, the access flap comprises
a first portion in one of the side panels and a second portion in one of the top panels foldably connected to the first portion.

8. The carton of claim 7 wherein the display panel is in face-to-face relationship with the one of the side panels and the one of the top panels.

9. The carton of claim 7 wherein the access flap is at least partially defined by a tear line at least partially forming the display opening.

10. The carton of claim 9, wherein the access flap is at least partially defined by a fold line that foldably connects the access flap to the at least one side panel.

11. The carton of claim 1 further comprising a reinforcement panel foldably connected to one of the side panels and the display panel.

12. The carton of claim 11 wherein the plurality of side panels comprises at least a first side panel, a second side panel foldably connected to the first side panel and comprising the display feature, a third side panel foldably connected to the second side panel, and a fourth side panel foldably connected to the third side panel, the one of the side panels being the fourth side panel, the reinforcement panel is in face-to-face relationship with the first side panel, and the display panel is in face-to-face relationship with another of the side panels.

13. The carton of claim 1 wherein the plurality of side panels comprises a front side panel and a rear side panel, the carton comprises a front top panel foldably connected to the front side panel and a rear top panel foldably connected to the rear side panel, the front top panel and the rear top panel each comprise handle features for forming a handle of the carton.

14. The carton of claim 13 wherein the handle features comprise a front handle panel foldably connected to the front top panel and a rear handle panel foldably connected to the rear top panel, the front handle panel and the rear handle panel each having a respective handle opening.

15. The carton of claim 1 wherein the carton comprises a plurality of top panels respectively foldably connected to a respective one of the plurality of side panels and operative for providing opened and closed configurations of the carton, the plurality of top panels is operative for defining opposite gable areas in the closed configuration of the carton.

16. The carton according to claim 15, wherein:
the plurality of top panels includes at least one top panel that includes at least one fold line for defining at least first and second sections of the top panel; and
at least the first and second sections are in an overlapping relationship with a respective adjacent top panel of the plurality of top panels in the closed configuration.

17. The carton of claim 1, wherein the bottom end flaps are operative for automatically forming the bottom in response to predetermined folding of the plurality of side panels.

18. A blank for forming a carton for holding at least one article, the blank comprising:
a plurality of side panels for extending at least partially around an interior of the carton formed from the blank, at least one of the plurality of side panels comprises a display feature;
a plurality of bottom end flaps respectively foldably connected to respective side panels of the plurality of side panels, wherein the bottom end flaps are for at least partially forming a closed bottom of the carton; and
a display panel for being positioned in face-to-face relationship with the at least one of the plurality of side panels and being adjacent the display feature in the carton formed from the blank.

19. The blank of claim 18 wherein the display panel comprises a side panel portion and a top flap foldably connected to the side panel portion.

20. The blank of claim 19 wherein the top flap comprises a plurality of lateral fold lines extending across the top flap to facilitate bending of the top flap.

21. The blank of claim 19 wherein the side panel portion is foldably connected to one of the plurality of side panels.

22. The blank of claim 18 wherein the display feature comprises an access flap removably connected to the at least one side panel for forming a display opening, the display panel is for being positioned relative to the access flap for being displayed in the display opening upon at least partial removal of the access flap in the carton formed from the blank.

23. The blank of claim 22 further comprising a plurality of top panels respectively foldably connected to respective side panels of the plurality of side panels, the access flap comprises a first portion in one of the side panels and a second portion in one of the top panels foldably connected to the first portion.

24. The blank of claim 22 wherein the access flap is at least partially defined by a tear line at least partially forming the display opening.

25. The blank of claim 24, wherein the access flap is at least partially defined by a fold line that foldably connects the access flap to the at least one side panel.

26. The blank of claim 18 further comprising a reinforcement panel foldably connected to one of the side panels and the display panel.

27. The blank of claim 26 wherein the plurality of side panels comprises at least a first side panel, a second side panel foldably connected to the first side panel and comprising the display feature, a third side panel foldably connected to the second side panel, and a fourth side panel foldably connected to the third side panel, the one of the side panels being the fourth side panel, the reinforcement panel is for being in face-to-face relationship with the first side panel in the carton formed from the blank, and the display panel is for being in face-to-face relationship with another of the side panels in the carton formed from the blank.

28. The blank of claim 18 wherein the plurality of side panels comprises a front side panel and a rear side panel, the carton comprises a front top panel foldably connected to the front side panel and a rear top panel foldably connected to the rear side panel, the front top panel and the rear top panel each comprise handle features for forming a handle of the carton formed from the blank.

29. The blank of claim 28 wherein the handle features comprise a front handle panel foldably connected to the front top panel and a rear handle panel foldably connected to the rear top panel, the front handle panel and the rear handle panel each having a respective handle opening.

30. The blank of claim 18 wherein the carton comprises a plurality of top panels respectively foldably connected to a respective one of the plurality of side panels and operative for providing an opened and closed configurations of the carton formed from the blank, the plurality of top panels has features that are operative for defining opposite gable areas in the closed configuration of the carton formed from the blank.

31. The blank according to claim 30, wherein:
the plurality of top panels includes at least one top panel that includes at least one fold line for defining at least first and second sections of the top panel; and
at least the first and second sections are for being in an overlapping relationship with a respective adjacent top panel of the plurality of top panels in the closed configuration of the carton formed from the blank.

32. The blank of claim 18, wherein the bottom end flaps are operative for automatically forming the bottom of the carton formed from the blank in response to predetermined folding of the plurality of side panels.

33. A method of assembling a carton comprising:
obtaining a blank comprising a plurality of side panels, at least one of the plurality of side panels comprises a display feature, a plurality of bottom end flaps respectively foldably connected to respective side panels of the plurality of side panels, and a display panel;
positioning the side panels to at least partially enclose an interior of the carton;
positioning the display panel to be in face-to-face relationship with the at least one of the plurality of side panels wherein the display panel is adjacent the display feature;
forming a closed bottom by positioning the bottom end flaps to at least partially form the closed bottom of the carton.

34. The method of claim 33 wherein the positioning an exterior surface of the display panel is in face-to-face contact with an interior surface of the at least one of the plurality of side panels.

35. The method of claim 33 wherein the display feature comprises an access flap removably connected to the at least one side panel, the method comprises at least partially removing the access flap from the at least one side panel to form a display opening that displays the display panel upon removal of the access flap.

36. The method of claim 35 further comprising a plurality of top panels respectively foldably connected to respective side panels of the plurality of side panels, the access flap comprises a first portion in one of the side panels and a second portion in one of the top panels foldably connected to the first portion.

37. The method of claim 36 wherein the display panel is in face-to-face relationship with the one of the side panels and the one of the top panels prior to removal of the access flap.

38. The method of claim 33 wherein the blank further comprises a reinforcement panel foldably connected to one of the side panels and the display panel.

39. The method of claim 38 wherein the plurality of side panels comprises at least a first side panel, a second side panel foldably connected to the first side panel and comprising the display feature, a third side panel foldably connected to the second side panel, and a fourth side panel foldably connected to the third side panel, the one of the side panels being the fourth side panel, the positioning the display panel comprises positioning the reinforcement panel in face-to-face relationship with the first side panel, and positioning the display panel in face-to-face relationship with another of the side panels.

40. The method of claim 33 wherein the plurality of side panels comprises a front side panel and a rear side panel, the carton comprises a front top panel foldably connected to the front side panel and a rear top panel foldably connected to the rear side panel, the front top panel and the rear top panel each comprise handle features, the method further comprises forming a handle of the carton.

41. The method of claim 40 wherein the handle features comprise a front handle panel foldably connected to the front top panel and a rear handle panel foldably connected to the rear top panel, the front handle panel and the rear handle panel each having a respective handle opening, and forming the handle comprises placing the front handle panel and rear handle panel in face-to-face contact.

42. The method of claim 33 wherein the blank comprises a plurality of top panels respectively foldably connected to a respective one of the plurality of side panels and operative for providing opened and closed configurations of the carton, the method comprising positioning the top panels to form a closed configuration that comprises opposite gable areas.

43. The method of claim 42, wherein:
the plurality of top panels includes at least one top panel that includes at least one fold line for defining at least first and second sections of the top panel; and
the positioning the top panels to form a closed configuration comprises positioning at least the first and second sections in an overlapping relationship with a respective adjacent top panel of the plurality of top panels.

44. The method of claim 33, wherein the forming a closed bottom comprises positioning the bottom end flaps automatically in response to the positioning of the plurality of side panels.
